(19) United States
(12) Patent Application Publication
(10) Pub. No.: US 2018/0343897 A1
(43) Pub. Date: Dec. 6, 2018

(54) COMPOSITIONS AND METHODS FOR RECONSTITUTED BITS

(71) Applicant: The Coca-Cola Company, Atlanta, GA (US)

(72) Inventors: Sheng Kui ZHU, Atlanta, GA (US); David WANG, Atlanta, GA (US); Kerri YING, Atlanta, GA (US); Jianping LIAO, Atlanta, GA (US); Alonso GARCIADEBLANES, Atlanta, GA (US)

(21) Appl. No.: 15/549,979

(22) PCT Filed: Feb. 9, 2016
(86) PCT No.: PCT/US16/17088

§ 371 Date: Aug. 9, 2017

(30) Foreign Application Priority Data
Feb. 9, 2015 (CN) 201510067085.X

(51) Int. Cl. A23L 2/52; A23L 2/02; A23L 2/54; A23L 2/60; A23L 19/00

(52) U.S. Cl. CPC A23L 2/52; A23L 2/02; A23V 2002/00; A23L 2/60; A23L 19/09; A23L 2/54

(57) ABSTRACT

The principles of the present invention provide compositions and methods for making fruit-like textured chunks, with an interior fiber-like texture, that is juicy and mimics real fruit bits. The method may include combining fruit puree/juice with protein and optionally treated with a gas to simulate the elastic and smooth organoleptic properties of fruit chunks.

### CROSS REFERENCE TO RELATED APPLICATIONS

This application is a 371 National. Stage Application of International Application No. PCT/US2016/017088, filed Feb. 9, 2016, which claims benefit of Chinese Application No. 201510067085.X, filed Feb. 9, 2015, herein incorporated by reference in their entirety.

### FIELD OF THE INVENTION

The principles of the present invention relate generally to the field of food products and beverages. In particular, composition and methods for producing reconstituted fruit bits that can simulate real chunks of fruit are provided by the principles of the present invention.

### BACKGROUND OF THE INVENTION

Beverages with particulates are very popular with consumers. For instance, certain dairy products with fruit chunks, bubble tea with tapioca balls, orange juice with pulp, and peach juice with peach chunks are very prevalent in the marketplace. Unfortunately, along with the cost and production difficulties associated with preparing chunks and bits from real fruit, many fruits are subject to seasonal supply and meeting the consumer demand year-round is challenging. Furthermore, natural fruit chunks and bits are subject to degradation (softening and browning) during shelf-storage. Therefore, development of new products and formulations capable with satisfactory nutritional characteristics, flavor profiles, and mouth-feel represents an ongoing challenge for the beverage industry.

### SUMMARY OF THE INVENTION

In one aspect, the principles of the present invention provide an artificial fruit composition. The composition may include a fruit juice or puree. In certain embodiments, the fruit is selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof. Alternative fruits may also be utilized.

In certain embodiments, the composition includes an alginate salt, or a pectin, or a gellan gum, or its combination. In some embodiments, the composition includes alginate salt from about 0.2-30 g/L.

In other embodiments, the composition includes a milk protein or plant protein from about 0-200 g/L. In some embodiments, the milk protein is selected from the group consisting of casein, lactalalbumin, and lactoglobulin.

In certain embodiments, the composition includes calcium from about 0.3-6 g/L as calcium ions.

In some embodiments, the composition is filled with a gas. In yet other embodiments, the gas is selected from the group consisting of air, nitrogen, and carbon dioxide.

In certain embodiments, the composition exhibits organoleptic, functional or nutritional characteristics similar to a natural, raw fruit bit.

The composition may include natural or artificial, non-nutritive or nutritive sweetener. In some embodiments, the non-nutritive sweetener includes at least one selected from the group consisting of Stevia rebaudiana extract, stevioside, cyclamate, neotame, erythritol, luo han guo, monk fruit, aspartame, saccharine, acesulfame potassium, and sucralose, or any combination or derivative thereof. In one embodiment the non-nutritive sweetener is rebaudioside A (Reb A). In yet another embodiment, the composition includes a nutritive sweetener. In some embodiments, the nutritive sweetener includes at least one selected from the group consisting of sucrose, fructose, glucose, polydextrose, and trehalose, from natural or purified sources or any combination or derivative thereof. In certain embodiments, the composition includes an additive selected from the group consisting of salts, food-grade acids, caffeine, emulsifiers, stabilizers, antioxidants, coloring agents, preservatives, energy-boosting agents, tea, botanicals, coffee, minerals and vitamins.

The principles of the present invention may provide a method of producing an artificial fruit composition, where the method may combine a fruit juice or puree with an alginate salt, milk protein, and calcium to produce a reconstituted fruit mixture. In some embodiments, the method includes setting the reconstituted fruit mixture. In particular embodiments, the method includes cutting the reconstituted fruit mixture into pieces and/or shapes to produce reconstituted fruit bits.

In other embodiments, the method includes injecting and/or releasing gas into the reconstituted fruit mixture. In one embodiment, the gas is selected from the group consisting of air, nitrogen, and carbon dioxide.

The fruit juice or puree may be selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof. Other fruits may also be utilized.

In certain embodiments, the method includes alginate salt from about 0.2-30 g/L.

In other embodiments, the method includes milk protein or plant protein from about 0-200 g/L.

The milk protein may be selected from the group consisting of casein, lactalalbumin, and lactoglobulin. In certain embodiments, the method includes calcium from about 0.3-6 g/L.

In certain embodiments, the method includes producing a reconstituted fruit bit exhibiting organoleptic, functional or nutritional characteristics similar to a natural, raw fruit bit.

The production method may include producing a composition including natural, or artificial, non-nutritive or nutritive sweetener. In some embodiments, the method includes producing a composition including a non-nutritive sweetener including at least one selected from the group consisting of Stevia rebaudiana extract, stevioside, cyclamate, neotame, erythritol, luo han guo, monk fruit, acesulfame potassium, aspartame, saccharine, and sucralose, or any combination or derivative thereof. In one embodiment the method includes producing a composition including the non-nutritive sweetener rebaudioside A (Reb A). In yet another embodiment, the method includes producing a composition including a nutritive sweetener. In some embodiments, the method includes producing a composition including a nutritive sweetener including at least one selected from the group consisting of sucrose, fructose, glucose, polydextrose, and trehalose, from natural or purified sources. In certain embodiments, the method includes producing a composition including an additive selected from the group consisting of salts, food-grade acids, caffeine, emulsifiers, stabilizers, antioxidants, coloring agents, preservatives, energy-boosting agents, tea, botanicals, coffee, minerals and vitamins

These and other features, aspects, and advantages of the principles of the present invention will become better understood with reference to the following description and claims.

### BRIEF DESCRIPTION OF THE FIGURES

FIG. 1. Schematic representation of reconstituted fruit bit with protein particles for fiber-like texture and, optionally, formed with gas injection or release during setting.

FIG. 2. Illustration of reconstituted fruit bits.

FIG. 3. Flow-chart for the preparation of reconstituted fruit bits with protein.

FIG. 4. Flow-chart for the preparation of reconstituted fruit bits formed with gas injection or release.

FIG. 5. Graph representing relative hardness of reconstituted fruit bits and natural, raw fruit bits.

FIG. 6. Graph representing relative hardness of reconstituted fruit bits before and after processing.

FIG. 7. Histogram representing relative protein content in a liquid matrix containing reconstituted fruit bits before and after shelf storage.

### DETAILED DESCRIPTION OF THE INVENTION

The principles of the present invention are based at least in part on the surprising discovery that a reconstituted fruit bit, comprising fruit juice or puree, an alginate salt, milk protein, and calcium can maintain the organoleptic characteristics (fiber-like texture and hardness) of natural, real fruit bits/chunks in a ready-to-drink beverage without losing structural stability after prolonged shelf storage. Additionally, the reconstituted fruit bit can be made to simulate the natural juiciness of raw fruit bits/chunks by using a gas during the manufacturing process to create small bubbles/holes in the reconstituted fruit bit which can trap juice or liquid. Accordingly, the principles of the present invention provide a reconstituted fruit bit with excellent texture and stability created using a novel process.

A common problem experienced various natural fruit-containing ready-to-drink beverages is that fruit bits/chunks deteriorate over time in beverage liquid becoming soft/mushy and unpalatable. Moreover, natural fruit is subject to limited year-round availability due to specific growing seasons. Particulates, particularly fruit bits/chunks, added to beverages are very popular and can deliver a multilayer texture which consumers enjoy (e.g., bubble tea, orange juice with pulp, grape juice with aloe vera bits, and sweetened milk/juice with nata de coco bits). Since most ready-to-drink beverages are not manufactured immediately on-site for potential consumers, such beverages are often stored for extended periods before consumption and any particulates in the beverages are to withstand degradation. While highly stable, artificial particulates can be readily manufactured, such particulates lack a natural, fruit-like texture and juiciness. The problem of palatable fruit bit/chunk particulates with acceptable mouth feel and fiber has not been adequately addressed by the prior art.

In order to address this long standing fruit degradation issue and create a reconstituted fruit bit with superior mouth-feel, juiciness, and stability, experiments have been conducted to develop a gel-like formulation which could simulate the fiber-like texture and porous juiciness or natural, raw fruit bits while still maintaining a commercially relevant shelf-life storage stability. The composition and processing of the reconstituted fruit bit mixture plays a significant role in how the reconstituted fruit bit tastes, feels, and reacts with the beverage liquid. Since a beverage with fruit-like particulates has a ready-to-drink action standard, certain functional levels and taste expectations are to remain consistent, thus making the creation of an artificial fruit bit/chunk difficult. As such, one of the structural and functional differences of the principles of the present invention is the unexpected parity in taste, mouth-feel, and functionality, once processed, to a standard, natural, raw fruit bit counterpart beverage. As a result of the extensive testing of various formulations, the principles of the present invention provide a reconstituted fruit bit that can be manufactured for all kinds of beverages without the risk of the reconstituted fruit bit substantially degrading in the beverage during storage while still maintaining similar organoleptic properties to an equivalent, natural, raw fruit bit-containing beverage.

Accordingly, the compositions and methods used herein also include methods of injecting and/or releasing gas during the preparation of the reconstituted fruit bits. Without being bound by theory, citric acid reacting with carbonated calcium in the reconstituted fruit bit mixture releases calcium ions (Ca²⁺) and CO₂ gas. The freed calcium ions react with the sodium alginate to form a gel wherein CO₂ is trapped and forms holes prior to escaping. Thus, when the reconstituted fruit bits are used in a beverage, the holes are filled with the juice or other beverage liquid causing the bits to appear juicy and similar in texture to real, raw fruit bits/chunks.

As used herein, “reconstituted fruit bit/chunk” is generally a irreversible, heat-stable (up to 150° C.) gel made from alginate, natural fruit juice/puree, milk protein, and calcium ions which can be formed into a desirable shape and/or size. In an embodiment, the shape is a cube from about 3 mm to about 8 mm in size. Alternative sizes may also be utilized. A typical example of a particulate beverage containing such a reconstituted fruit bit is fruit juice. In alternative embodiments, principles of the present invention can be used to provide beverages of carbonated and non-carbonated drinks, frozen ready-to-drink beverages, tea beverages, dairy beverages, as well as flavored waters, enhanced waters, fruit juice and fruit juice-flavored drinks, sports drinks, and alcoholic products. In an embodiment, the density of the reconstituted fruit bit can be altered by increasing or decreasing the amount of gas injected and/or released during setting of the reconstituted fruit mixture. In another embodiment, the hardness and texture of the reconstituted fruit bit can be varied by using different amounts of milk protein, known in the art, in the reconstituted fruit mixture. As appreciated by one of skill in the art, any of these beverages can be the starting material to be combined according to the methods herein, or are beverages to which reconstituted fruit bits can be added.

As used herein, “alginate salt” is the term used for the salts of alginic acid, but can also refer to alginic acid and all the derivatives thereof. In some publications the term “algin” is used instead of alginate. Alginate is present in the cell walls of brown algae as the calcium, magnesium and sodium salts of alginic acid.

As appreciated by one of skill in the art, water is a basic ingredient in the beverages disclosed here, typically being the primary liquid portion in which the high-concentrate beverage syrup is dissolved, emulsified, suspended or dispersed. Those of ordinary skill in the art will understand that, for convenience, some ingredients are described herein, in certain cases, by reference to the original form of the ingredient in which it is added to the beverage product formulation. Such original form may differ from the form in which the ingredient is found in the finished beverage product. For example, orange juice is generally made by extraction from the fresh fruit, by desiccation and subsequent reconstitution of dried juice, or by concentration of the juice and the subsequent addition of water to the concentrate. The beverage to be combined with a reconstituted fruit bit, for instance, can be fresh, can be one containing pulp, or can be one from which pulp has been removed by centrifugation or filtration.

Once made, the reconstituted fruit bit can find use as in a beverage of its own or can be mixed with one or more other particulates. Carbon dioxide can be used to provide effervescence to certain embodiments of the beverages disclosed herein. Any of the techniques and carbonating equipment known in the art for carbonating beverages can be employed.

As used herein, “electrolyte solution” refers to a drink containing sodium, potassium, magnesium, calcium, or zinc salts to replenish the body's electrolyte and ion levels which can become diminished by dehydration caused by exercise and/or heat. In certain embodiments, the particulate beverage includes an electrolyte solution of salts selected from the group consisting of sodium, potassium, magnesium, calcium, and zinc, or combinations thereof.

In other embodiments, the reconstituted fruit bit mixture includes sodium alginate from about 0.2-30 g/L. In particular embodiments, the reconstituted fruit bit mixture includes citric acid from about 5-20 g/L. In certain embodiments, the reconstituted fruit bit mixture includes calcium carbonate about 0.3-6 g/L as calcium. In some embodiments, the reconstituted fruit bit mixture includes sodium citrate about 0.3-1.5 g/L. In yet other embodiments, the reconstituted fruit bit mixture includes sucrose and/or glucose about 0-300 g/L.

The salts can be present at similar or different amounts relative to each other. At least the organoleptic, functional or nutritional properties of the reconstituted fruit bit is similar when compared to an equivalent natural, raw fruit bit.

As used herein, “equivalent natural, raw fruit bit” is a piece or chunk of a real fruit that has not been processed in accordance with the principles of the present invention.

As used herein, a “non-nutritive sweetener” is one that does not provide significant caloric content in typical usage amounts, i.e., is one that imparts less than 5 calories per 8 ounce serving of beverage to achieve the sweetness equivalent of 10 Brix of sugar. In various embodiments, the high-concentrate beverage syrup composition further includes a nonnutritive sweetener selected from Stevia rebaudiana extract, stevioside, cyclamate, neotame, erythritol, luo han guo, monk fruit, acesulfame potassium, aspartame, saccharine, and sucralose, or any combination or derivative thereof. In one embodiment the non-nutritive sweetener is rebaudioside A (Reb A).

As used herein, a “nutritive sweetener” is one that can provide significant caloric content in typical usage amounts, i.e., is one which imparts greater than 5 calories per 8 ounce serving of beverage to achieve the sweetness equivalent of 10 Brix of sugar. In various embodiments, the high-concentrate beverage syrup composition further includes a nutritive sweetener selected from the group consisting of sucrose, fructose, glucose, polydextrose, and trehalose, from natural or purified sources.

As used herein, degrees Brix (Tx) is the sugar content of an aqueous solution. One degree Brix is 1 gram of sucrose in 100 grams of solution and represents the strength of the solution as percentage by weight (% w/w).

It should be understood that beverages and other beverage products can have any of numerous different specific formulations or constitutions. In general, a beverage typically comprises at least water, acidulant, and flavoring. The beverage products in accordance with the principles of the present invention include beverages, i.e., ready to drink formulations and the like. Juices suitable for use in at least embodiments include, for example, fruit, vegetable, and berry juices. In beverages employing juice, juice may be used, for example, at a level from about 0.2%, about 0.5%, about 1%, about 2%, about 3%, about 5%, about 10%, about 15%, about 20%, about 25%, about 30%, about 35%, about 40%, about 50%, about 60%, about 70%, about 80%, about 90% to about 99% juice by weight of the beverage.

Accordingly, the principles of the present invention provide a method of producing a reconstituted fruit bit optionally comprising injecting and/or releasing a gas selected from the group consisting of air, nitrogen, and carbon dioxide. Beverages, of which the taste profiles may be modified by the addition of sweeteners, can be provided. Various beverages, such as fruit juices, can contain a significant amount of acid and, thus, increase the rate of deterioration of the reconstituted fruit bits contained therein.

To prepare a reconstituted fruit bit of the present invention standard colloid and protein science food and beverage formulation methods can be used. Examples of such methods can be found in U.S. Pat. Nos. 3,892,870, and 6,589,328, each of which is expressly incorporated herein by reference. The principles of the present invention provide a method of producing a reconstituted fruit bit comprising combining fruit puree or juice, an alginate salt, milk protein, and calcium to produce a reconstituted fruit mixture, setting the reconstituted fruit mixture, and then cutting the reconstituted fruit mixture into pieces to produce reconstituted fruit bits. Furthermore, the reconstituted fruit mixture can be optionally injected with a gas before, during, or after the mixing process.

Non-nutritive sweeteners, also called artificial sweeteners, or high-intensity sweeteners, are agents that exhibit a sweetness many times that of sucrose. Examples of high-intensity sweeteners include saccharin, cyclamate, aspartame, monatin, alitame, acesulfame potassium, sucralose, thaumatin, stevioside, glycyrrhizin, sucralose, and neotame. Therefore, beverages such as fruit juice, sports drinks, and soft drinks, are sweetened with non-nutritive sweeteners that may not occur naturally in the source ingredients for the beverage and thus are generally regarded as undesirable by many consumers. By contrast, nutritive sweeteners generally refer to naturally occurring substances. Examples of nutritive sweeteners include glucose, fructose, maltose, galactose, maltodextrin, trehalose, fructo-oligosaccharides, and trioses. Due to the prevalence and popularity of non-nutritive sweeteners in beverages, several processes have been described for modifying the taste profile of beverages that contain these non-nutritive sweeteners.

As used herein, “additive” means food additive, or a substance added to food to preserve flavor or enhance its taste and appearance. In some embodiments, the composition further includes an additive selected from salts, food-grade acids, caffeine, emulsifiers, stabilizers, antioxidants, coloring agents, preservatives, energy-boosting agents, tea, botanicals, coffee, minerals and vitamins. Further, it will generally be an option to add other ingredients to the formulation of a particular beverage embodiment, including flavorings, electrolytes, tastents, masking agents, flavor enhancers, carbonation, or caffeine.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1

Reconstituted Fruit Bits with Fruit Puree and Casein Protein

The following exemplifies the composition of reconstituted fruit bits using alginate salts (or gellan gum, pectin, or a mixture of both) to react with calcium salts to form a semisolid gel with fruit puree/juice and casein protein. The gel is irreversible and heat stable (up to 150° C.) in presence of calcium ions (Ca2+).

TABLE 1
Mixture preparation using casein protein.

| Part A | | Part B | |
|---|---|---|---|
| Alginate mix | Percent (%) | Fruit Mix | Percent (%) |
| Sodium alginate | 0.90 | Mango puree | 33.50 |
| Di-calcium phosphate | 0.35 | Citric acid | 0.90 |
| Sodium citrate | 0.07 | Sodium citrate | 0.65 |
| Sucrose | 10.00 | | |
| Casein | 3.00 | | |
| Water | 35.68 | Water | 14.95 |
| Total | 50 | | 50 |

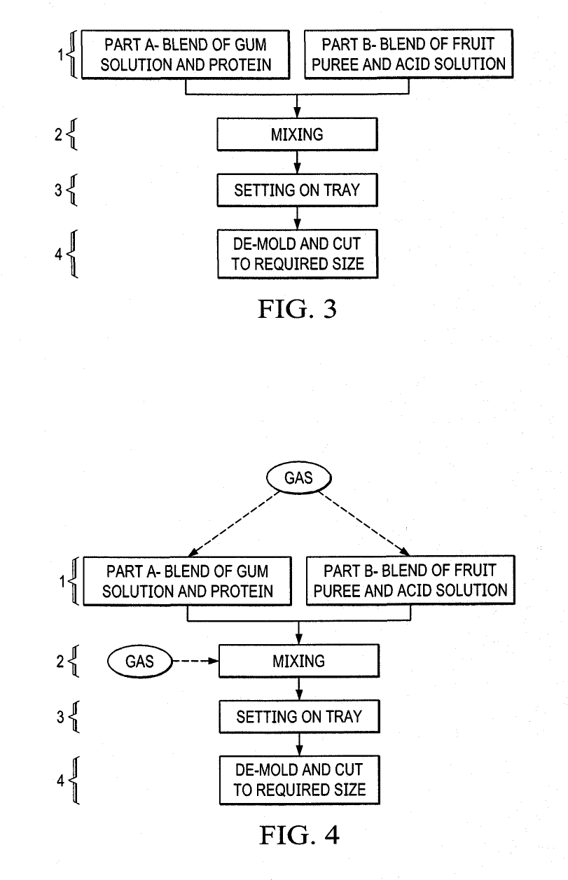

The combination of water, mango puree, sucrose, casein, sodium alginate, calcium lactate, citric acid, sodium citrate, and di-calcium phosphate (Table 1) was prepared using the following process (FIG. 3) to produce a single, homogenous structure containing small, solid particles resulting in an elastic, fruit-like texture (FIG. 2). The size of the reconstituted fruit bits was adjustable, with about 3 mm to about 8 mm cubic bits preferred. Alternative sizes may also be utilized.

Mixture part A was prepared by dispersing sodium alginate, casein, and other powders in water using a mixer. Separately, mixture part B was made by dissolving the component powders in water and blending well with fruit puree to remove any lumps (FIG. 3, step 1). The two separate preparations were then mixed together (FIG. 3; step 2) and quickly poured into setting trays where they were allowed to set until hard (FIG. 3; step 3). The block of reconstituted fruit was de-molded and moved to a cutter and cut into pieces of a predetermined size (FIG. 3; step 4) before being added to a liquid of choice, such as a prepared beverage.

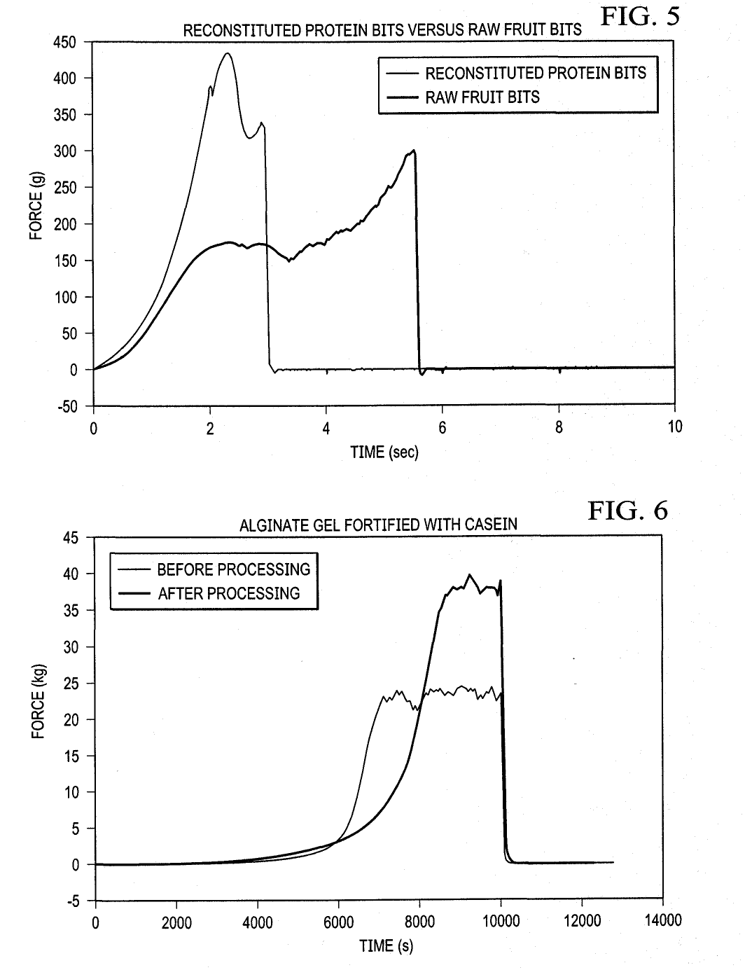

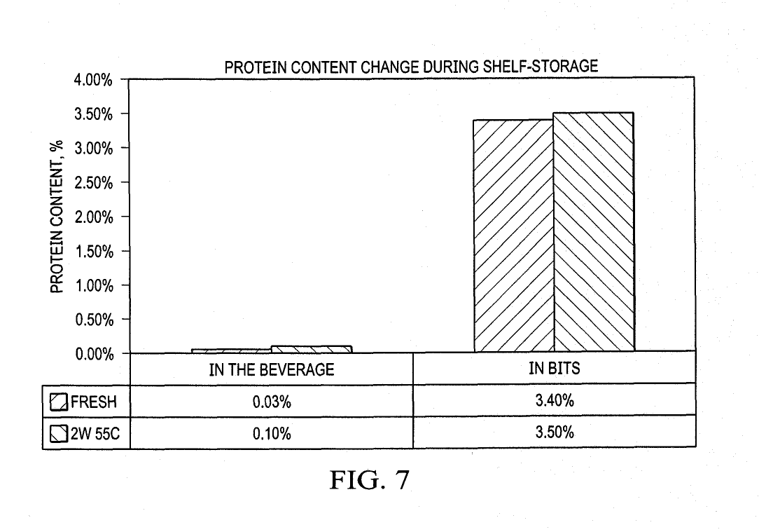

In order for reconstituted fruit bits to properly simulate natural fruit bits, the reconstituted fruit bits must be of sufficient hardness. Reconstituted fruit bits were prepared as described above and directly compared to real, raw fruit bits using a texture meter (TA.XTPlus by Texture Technologies Corp.). Results demonstrated that the reconstituted fruit bits were of greater hardness (FIG. 5). Similarly, reconstituted fruit bits were also tested for hardness before and after retort processing at 90° C. for 16 minutes. Results indicated that the hardness of reconstituted fruit bits increased after processing (FIG. 6).

Casein can be stably maintained in reconstituted fruit pieces. Results showed that casein protein was very stable inside reconstituted fruit bits following simulated storage (55° C. for 2 weeks) with little-to-no protein breakdown.

### Example 2

Gas Generated During Setting Process of Reconstituted Fruit Bits

The following exemplifies the composition of reconstituted fruit bits using alginate salts (or gellan gum, pectin, or a mixture of both) to react with calcium salts to form a semisolid gel with fruit puree/juice. During the setting process, CO₂ gas was generated from calcium carbonate to help form a sponge-like structure. The gel is irreversible and heat stable (up to 150° C.) in presence of calcium ions (Ca²⁺).

TABLE 2
Mixture preparation using calcium carbonate and no gas injection.

| Part A | | Part B | |
|---|---|---|---|
| Alginate mix | Percent (%) | Fruit Mix | Percent (% |
| Sodium alginate | 1.00 | Peach puree | 25.00 |
| Calcium carbonate | 0.45 | Citric acid | 0.90 |
| Sodium citrate | 0.07 | Sodium citrate | 0.65 |
| Sucrose | 3.00 | | |
| Water | 45.48 | Water | 23.45 |
| Total | 50 | | 50 |

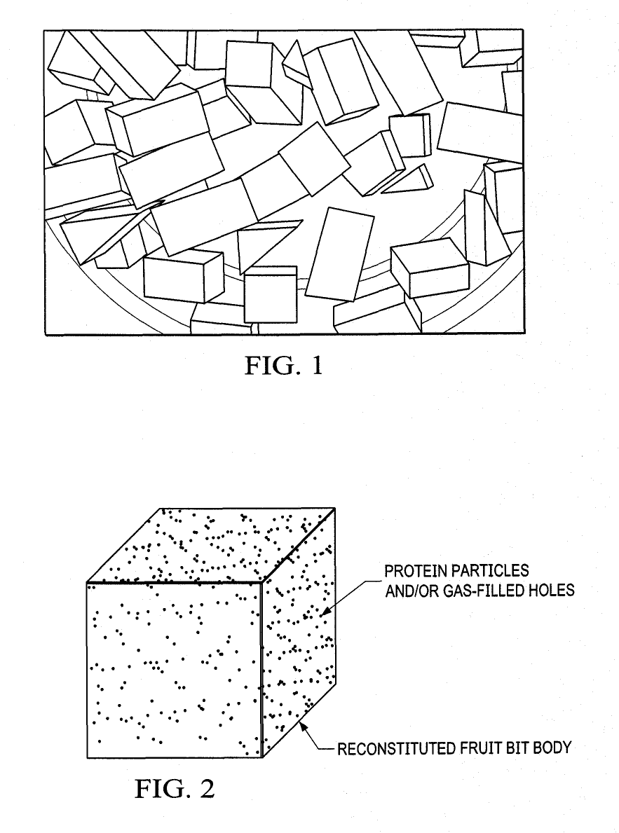

Parts A and B were prepared separately and then mixed together using a dynamic mixer (see FIG. 4). Without being limited by theory, the citric acid reacted with carbonated calcium to release calcium ions (Ca²±) and CO₂ gas. The freed calcium ions reacted with sodium alginate to form a gel, and CO₂ was trapped in the gel, thereby forming holes (FIG. 1). Density of the reconstituted peach fruit bits with CO₂ gas generation density was 0.7289 g/ml and 1.0601 g/ml without.

### Example 3

Gas Injected During Setting Process of Reconstituted Fruit Bits

In this example, gas (such as normal air, N₂, or CO₂) was injected in Parts A and/or B, thereby trapping the gas bubbles, and then Parts A and B were mixed together using a dynamic mixer (Table 3). Alternatively, gas can also be injected during the mixing step (FIG. 4). Without being limited by theory, the citric acid reacts with di-calcium phosphate to release calcium ions (Ca²⁺). Then the freed calcium ions react with sodium alginate to form a gel and gas is entrapped in the gel.

TABLE 3
Mixture preparation using di-calcium phosphate and gas injection.

| Part A | | Part B | |
|---|---|---|---|
| Alginate mix | Percent (%) | Fruit Mix | Percent (%) |
| Sodium alginate | 1.00 | Peach puree | 25.00 |
| Di-calcium phosphate | 0.45 | Citric acid | 0.90 |
| Sodium citrate | 0.07 | Sodium citrate | 0.65 |
| Sucrose | 3.00 | | |
| Water | 45.48 | Water | 23.45 |
| Total | 50 | | 50 |

Differing levels of reconstituted fruit bit density was achieved using various types of gas during the gas injection step. Density of the reconstituted peach fruit bits was measured; without gas injection=1.0601 g/ml and with N₂ gas injection=1.0046 g/ml.

1. An artificial fruit composition comprising fruit juice or puree, an alginate salt, milk protein, calcium, and optionally filled with a gas.

2. The composition of claim 1, wherein the fruit juice or puree is from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof.

3. The composition of claim 1, further comprising a non-nutritive sweetener.

4. The composition of claim 3, wherein the non-nutritive sweetener is selected from the group consisting of Stevia rebaudiana extract, stevioside, aspartame, saccharine, and sucralose.

5. The composition of claim 1, further comprising a nutritive sweetener.

6. The composition of claim 5, wherein the nutritive sweetener is selected from the group consisting of sucrose, fructose, and glucose, polydextrose, and trehalose, from natural or purified sources.

7. The composition of claim 1, further comprising an additive selected from the group consisting of salts, food-grade acids, caffeine, emulsifiers, stabilizers, antioxidants, coloring agents, preservatives, energy-boosting agents, tea, botanicals, minerals and vitamins

8. The composition of claim 1, wherein the gas is selected from the group consisting of carbon dioxide, nitrogen, and air.

9. A method of making an artificial fruit composition comprising:
combining fruit puree or juice, an alginate salt, milk protein, and calcium to produce a reconstituted fruit mixture;
setting the reconstituted fruit mixture; and
cutting the reconstituted fruit mixture into pieces to produce reconstituted fruit bits, wherein the reconstituted fruit mixture is optionally injecting with a gas.

10. The method of claim 9, wherein combining the fruit juice or puree includes combining fruit juice or puree from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof.

11. The method of claim 9, wherein combining further includes combining a non-nutritive sweetener.

12. The method of claim 11, wherein combining the non-nutritive sweetener includes combining non-nutritive sweetener selected from the group consisting of Stevia rebaudiana extract, stevioside, aspartame, saccharine, and sucralose.

13. The method of claim 9, wherein combining further includes combining a nutritive sweetener.

14. The method of claim 13, wherein combining the nutritive sweetener includes combining nutritive sweetener selected from the group consisting of sucrose, fructose, and glucose, polydextrose, and trehalose, from natural or purified sources.

15. The method of claim 9, wherein combining further includes combining an additive selected from the group consisting of salts, food-grade acids, caffeine, emulsifiers, stabilizers, antioxidants, coloring agents, preservatives, energy-boosting agents, tea, botanicals, minerals and vitamins

16. The method of claim 9, wherein optionally injecting gas includes optionally injecting gas selected from the group consisting of carbon dioxide, nitrogen, and air.
